(19) United States
(12) Patent Application Publication
(10) Pub. No.: US 2011/0196733 A1
(43) Pub. Date: Aug. 11, 2011

(54) Optimizing Advertisement Selection in Contextual Advertising Systems

(76) Inventors: Wei Li, Sunnyvale, CA (US); Ruofei (Bruce) Zhang, San Jose, CA (US); Ying Cui, Sunnyvale, CA (US); Jianchang (JC) Mao, San Jose, CA (US)

(21) Appl. No.: 12/701,031

(22) Filed: Feb. 5, 2010

(51) Int. Cl. G06Q 30/00

(52) U.S. Cl. 705/14.42

(57) ABSTRACT

A contextual advertising system optimizes computer selection of low performance ranked messages and high performance ranked messages for display on a network location. The system divides a ranked group of online messages into a first list, a second list, and a promotion set. Each message in the first list has a performance score that is greater than each performance score of messages in the second list and the promotion set. The system moves a message within the promotion set to a third list as a function of a confidence value and moves a message from one of the third list and the second list to the first list based on an experiment event outcome. The system transmits top messages in the first list over a network for display at a recipient computer.

### BACKGROUND

1. Field

The information disclosed relates to online advertising. More particularly, the information disclosed relates to improving a likelihood of displaying on a webpage originally low performance ranked advertisements based on a low confidence in that original ranking.

2. Background Information

The marketing of products and services online over the Internet through advertisements is big business. In February 2008, the IAB Internet Advertising Revenue Report conducted by PricewaterhouseCoopers announced that PricewaterhouseCoopers anticipated the Internet advertising revenues for 2007 to exceed US$21 billion. With 2007 revenues increasing 25 percent over the previous 2006 revenue record of nearly US$16.9 billion, Internet advertising presently is experiencing unabated growth.

Unlike print and television advertisement that primarily seeks to reach a target audience, Internet advertising seeks to reach target individuals. The individuals need not be in a particular geographic location and Internet advertisers may elicit responses and receive instant responses from individuals. As a result, Internet advertising is a much more cost effective channel in which to advertise.

Contextual advertising is the task of displaying on webpages ads from a pool of ads based on the content displayed to the user. A goal is to display ads that are relevant to the user, in the context of the page, so that a satisfied user clicks on the ad, thereby generating revenue for the webpage owner and the advertising network.

### SUMMARY

A contextual advertising system optimizes computer selection of low performance ranked advertisements and high performance ranked advertisements for display on a network location. The system divides a ranked group of online advertisements into a first list, a second list, and a promotion set. Each advertisement in the first list has a performance score that is greater than each performance score of advertisements in the second list and the promotion set. The system moves a advertisement within the promotion set to a third list as a function of a confidence value and moves a advertisement from one of the third list and the second list to the first list based on an experiment event outcome. The system transmits top advertisements in the first list over a network for display at a recipient computer.

### BRIEF DESCRIPTION OF THE FIGURES

FIG. 1 is a flow diagram illustrating a contextual advertising method 100 to select a low performance ranked advertisement for display on a network location.

FIG. 2 is a block diagram illustrating a system 200 to select and then display a low performance ranked advertisement on a network location.

FIG. 3 is a block diagram illustrating an advertisement database 300.

FIG. 4 is a block diagram illustrating levels of granularity for a page-ad pair 400.

FIG. 5 is a flow diagram illustrating a method 500 to divide a group of advertisements into a first list, a second list, and a promotion set at processing block 120.

FIG. 6 is a flow diagram illustrating a method 600 to utilize a confidence metric to select an advertisement randomly within promotion set 310 to move from promotion set 310 to separation queue 308.

FIG. 7 is an example plot 700 of tan h function C₁=tan h(imp/b) with the hyperbolic angle imp/b on the x-axis and the confidence value C₁ on the y-axis.

FIG. 8 illustrates an example beta-binomial (n=30, α=10, β=7) distribution 800, together with its best matching binomial distribution.

FIG. 9 is a flow diagram illustrating a method 900 to move an advertisement within the third list or the second list to the first list.

FIG. 10 is a flow diagram illustrating a method 1000 to display advertisements 312 and 318 within top ads queue 304 on webpage 260 as ads 264.

FIG. 11 is a diagrammatic representation of a network 1100.

### DETAILED DESCRIPTION

A webpage may include multiple advertising impression locations into which an ad server may serve advertisements. The following describes a computer-implemented system and methods to move certain low-performing advertisements up in rank to be within a list of top performing advertisements. This may give the upranked advertisement a better chance at having a system display them on a network location, such as a webpage, and give each upranked/displayed advertisement a better chance at having a user click onto it. By displaying partially tested advertisements in some of the available advertising impression location and displaying enough high performing advertisements in the remaining locations to maintain advertising revenue, an advertising system may continually rejuvenate and expand its list of high performing advertisements while avoiding user fatigue and ineffective advertising-budget management.

In online advertising, certain advertisements are more likely to win an advertising impression opportunity and, once displayed, users are more likely to click on that advertisement over time in comparison to other advertisements. While advertising systems desire such high performing advertisements, their success may lead to problems. For example, advertisements with large numbers of actual impressions and high click through rates are usually the top candidates to display in future advertising impression opportunity auctions and therefore get more impressions and clicks in the future. Their iterative, rich-get-richer success works to drive other advertisements into bad performer categories, sometimes undeservedly so. In other words, the longer an advertisement is in the system, the more likely that it will be a high-performer, and the more likely other later in time, newer advertisements will be at a disadvantage. A result is that most impressions will go to a small group of elite, older advertisements. Thus, an advertising system may not give a remaining large percentage of advertisements a chance at display to prove their worth in front of the online viewing public.

In fast changing marketplaces, an advertising system constantly receives new advertisements as candidates for display on a webpage. However, because new advertisements come to the advertising system later in time, they enter with a significant likelihood-of display disadvantage to those advertisements in the system that have already achieved high performing status. As a result, users may see the same group of ads over time and become fatigued by their presence. In addition, high performing advertisements may quickly burn up the advertising campaign budge of an advertiser so that the advertiser loses the benefit of having their promotion in front of the public over long periods. Because of their momentum, high performing advertisements in a performance based advertising ranking system may prevent their own replacement by upcoming advertisements even after the point in which the high performing advertisement become less effective and less economical.

To address these and other issues, the below describes an advertising system in which advertisements first are ranked based on their click feedback score (their nCTR score) and then divided in ranked order into several lists and a promotion set. Those advertisements in the first list have the highest click feedback scores. Those advertisements in the promotion set will have relatively low click feedback scores. However, the advertising system may determine a low confidence in the correctness of some of the click feedback scores for advertisements within the promotion set. A remaining process may look at advertisements within the promotion set and utilizes a confidence level metric ultimately to add advertisements within the promotion set to the first list.

In general, the less confident the advertisement system is in the click feedback score for a given advertisement in the promotion set, the more likely that the advertising system will move that advertisement from the promotion set into the first list. This makes sense since the advertising system originally excluded the advertisement from the first list based on the click feedback score of that advertisement. If the advertising system concluders that there is a low confidence in that click feedback score, then the advertisement should be give a chance to prove its performance before the viewing public. Once the advertising system modifies the first list with certain low-performing advertisements, the advertising system then may select advertisements from the modified first list for display on a webpage. In other words, the advertising system then may choose one or more of the advertisements in the first list for display on a webpage. By displaying partially tested (or untested) advertisements before the public, the advertising system will give these advertisements a chance to receive click throughs to prove their worth in front of the public. Should an advertisement successfully prove itself, then the advertising system may add that advertisement to the list of high performing advertisements.

General Online Advertising

In the following description, numerous details are set forth for purpose of explanation. However, one of ordinary skill in the art will realize that a skilled person may practice the methods without the use of the specific details. In other instances, the disclosure may show well-known structures and devices in block diagram form to prevent unnecessary details from obscuring the written description.

In the examples described below, users may access an entity, such as, for example, a content service-provider, over a network such as the Internet and further input various data, which the system subsequently may capture by selective processing modules within the network-based entity. The user input typically comprises “events.” In one example, an event may be a type of action initiated by the user, typically through a conventional mouse click command. Events include, for example, advertisement clicks, search queries, search clicks, sponsored listing clicks, page views, and advertisement views. However, events, as used herein, may include any type of online navigational interaction or search-related events.

Each such event initiated by a user may trigger a transfer of content information to the user. The user may see the displayed content information typically in the form of a webpage on the user's client computer. The webpage may incorporate content provided by publishers, where the content may include, for example, articles, and/or other data of interest to users displayed in a variety of formats. In addition, the webpage also may incorporate advertisements provided on behalf of various advertisers over the network by an advertising agency, where the advertising agency may be included within the entity, or in an alternative, the system may link the entity, the advertisers, and the advertising agency, for example.

Contextual Advertising and the nCTR Model

In a broader sense, contextual advertising includes a task of displaying advertisements on webpages under conditions in which the content of the webpages exist or occurs. A goal is to display ads that are relevant to the user, in the context of the page, to improve the user's experience and so that the user clicks on the ad, thereby generating revenue for the webpage owner and the advertising network (e.g., Yahoo!™). In addition, advertisements on each webpage should be relevant to the user's interest to avoid degrading the user's experience and to increase the probability of reaction from the user.

An advertisement may be relevant to the context of a webpage in many different ways. A most straightforward situation may be when the advertisement and the webpage share common words. An advertising system also may find relevant an advertisement that does not match any word in the webpage. For example, the advertisement may not have the same vocabulary as the webpage but be conceptually related to a category or topic of the webpage or the website hosting the webpage. Even if the advertisement is not about the same topic as the webpage or the website hosting the webpage, the advertisement still may be of interest to the same group of users. In such as situation, semantic features are no longer effective to describe webpage-advertisement similarity. Thus, in addition to ranking advertisements based on webpage-advertisement similarity, an advertising system also may utilize historical performance to rank advertisement accordingly to a desire in serving them to an advertisement-impression opportunity.

Marketing mix modeling (MMM) is a system that utilizes multivariate regressions and other statistical analysis to estimate an impact of various promotional tactics on sales. MMM then forecasts the impact of future sets of promotional tactics. In the online world, advertising systems may use the click-through rate to gauge the historical performance of a displayed advertisement.

In general, click-through rate (CTR) is a way of measuring the success of an online advertising campaign using the ratio between numbers of clicks and impressions. An advertising system may obtain a CTR by dividing the number of users who clicked on an advertisement on a webpage by the number of times the advertising system delivered the advertisement to webpages (e.g., the number of impressions). For example, if an advertising system delivered a banner advertisement one-hundred times to various webpages (“made one-hundred impressions”) and one person depressed a button on a computer mouse to select the advertisement (one click recorded), then a resulting CTR would be one-percent (( 1/100)*100%).

The advertising system may deem as a page-ad pair a single advertisement impressed onto a webpage. For each pair of webpage and ad, the advertising system may use the click-through rate (CTR) to compute a click feedback score (nCTR score). The advertising system may base the nCTR score on historical impression and click-through statistics at different levels of granularity or subdivisions of the system. For a given webpage, the advertising system may rank the advertisements according to their nCTR scores and then display at least some of the high nCTR ranked (higher performance) advertisements.

As noted above, an exclusive history-based advertisement ranking approach utilized by the nCTR model may suffer from the rich-get-richer phenomenon over time. For example, advertisements can only receive a click-through if displayed or impressed upon a webpage. Advertisements with large numbers of impressions and high click-through rates usually become the top candidates to display in an exclusive history-based advertisement ranking approach and therefore get more impressions and clicks in the future. On the other hand, advertisements with low impressions tend to have few or no clicks and deemed bad performers under such a model. Their chances for future impression will be even lower regardless of their relevancy. This may be especially bad news for a fast changing marketplace where an advertising system constantly may receive new advertisements.

In the nCTR model, new advertisements are not as competent as the established good performers and it may be difficult for the new advertisements to catch up. In the long term, most impressions will go to a small group of advertisements, which may cause various problems such as user fatigue and ineffective budget management. Repeatedly displaying the same group of advertisements may severely impair the user experience and those advertisements already identified high performance advertisements may burn up marketing budget quickly, which hurts advertisers.

To address these and other issues, an advertising system should discover potentially good advertisements while preserving revenue. To this end, the advertising system may measure a level of assuredness or confidence in each nCTR scores. A low confidence in a given nCTR score could mean that the advertising system is some what wrong in viewing a low nCTR scoring advertisement as a poor performer. To explore this, the advertising system further may work with the low nCTR scoring advertisement to increase its rank among the nCTR ranked advertisements. By ranking the low nCTR scoring advertisement higher among the nCTR ranked advertisements, the advertising system then may present that advertisement before the online public to receive click-throughs.

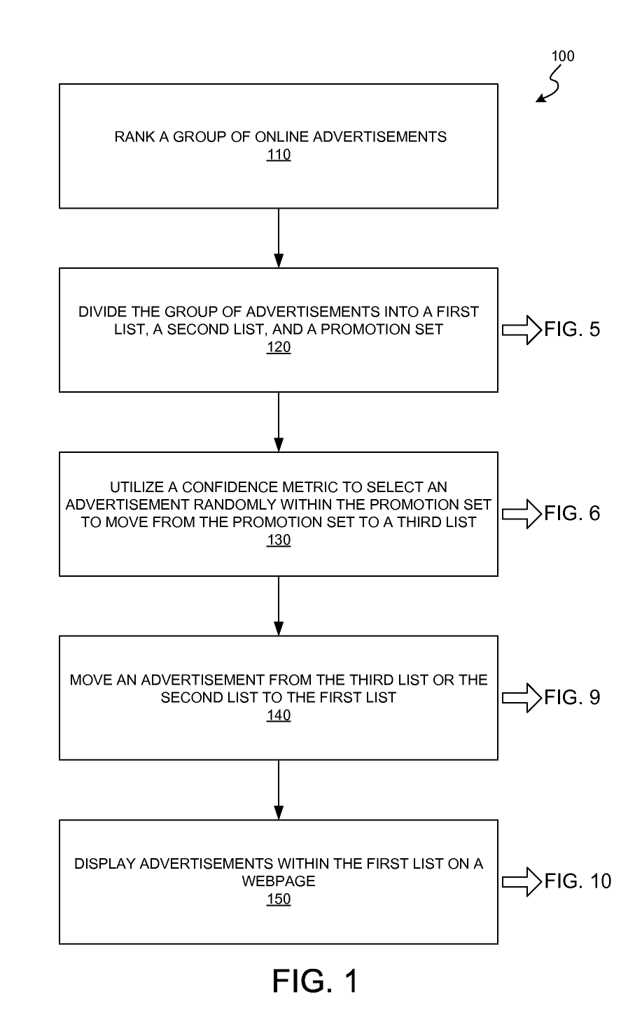

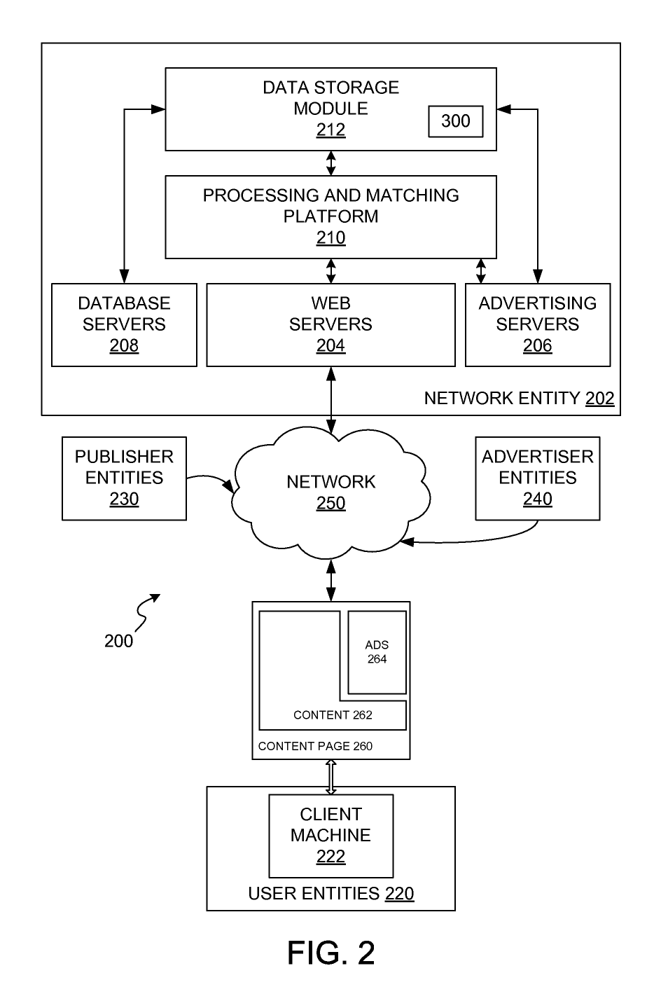

FIG. 1 is a flow diagram illustrating a contextual advertising method 100 to select a low performance ranked advertisement for display on a network location. Advertising system 200 (FIG. 2) may implement method 100 in a computer. In general, method 100 may move a given advertisement up in rank based on a low confidence in the original performance rank of that advertisement.

At processing block 110, method 100 may rank a group of online advertisements. The online advertisements may be discrete communication devices utilized to help inform the public about products and services. Advertising system 200 may apply processing block 110 to arrange the group of online advertisements according to their relative status so that each advertisement has a position relative to other advertisements in the group.

At processing block 120, method 100 may utilize the ranked order of the advertisements to divide the group of advertisements into a first list, a second list, and a promotion set. Those advertisements in the first list may have the highest click feedback scores, meaning that advertising system 200 may view these advertisements as high performers. Those advertisements in the second list may be all advertisements other than those in the first list. Those advertisements in the promotion set may have low click feedback scores, meaning that advertising system 200 may view these advertisements as low performers.

At processing block 130, method 100 may utilize a confidence metric to select an advertisement randomly within the promotion set to move the selected advertisement from the promotion set to a third list. At processing block 140, advertising system 200 may move an advertisement within the third list or the second list to the first list. Advertising system 200 may perform processing block 130 by flipping a coin, for example. At processing block 150, advertising system 200 may display advertisements within the first list on a webpage.

FIG. 2 is a block diagram illustrating a system 200 to select and then display a low performance ranked advertisement on a network location. System 200 may be a structure having an exemplar/network-based network entity 202 connected to user entities 220, publisher entities 230, and advertiser entities 240 through a network 250. Each may cooperate to deliver a content page 260 having content 262 and advertisements 264 to user 220. Advertisements 264 may include advertisements moved up in performance rank after applying method 100.

The description conveys system 200 within the context of network entity 202 to enable up ranking and display of advertisements 264. However, it will be appreciated by those skilled in the art that the methods will find application in many different types of computer-based, and network-based, entities, such as, for example, commerce entities, content provider entities, or other known entities having a presence on network 250.

Network entity 202 may be a device that has a distinct, separate existence and includes an autonomous computer that performs calculations automatically. Network entity 202 may communicate through network 250. In one example, network entity 202 may be a network content service provider, such as, for example, Yahoo!™ and its associated properties. Network entity 202 may include front-end web processing servers 204, which may, for example, deliver content pages 260 and other markup language documents to multiple users, and/or handle search requests to network entity 202. Web servers 204 may provide automated communications to/between users of network entity 202. Display may include a presentation to communicate particular information. Here, web servers 204 may deliver images for display within webpages 260, and/or deliver content information to the users in various formats.

Network entity 202 further may include processing servers to provide an intelligent interface to the back-end of network entity 202. For example, network entity 202 may include back-end servers, for example, advertising servers 206, and database servers 208. Each server may maintain and facilitate access to data storage modules 212. In one example, advertising servers 206 may be coupled to data storage module 212 and may transmit and receive advertising content, such as, for example, advertisements, sponsored links, integrated links, and other known types of advertising content, to/from advertiser entities via network 250.

Network entity 202 further may include a processing and matching platform 210 coupled to data storage module 212. The system may connect platform 210 and web servers 204. In addition, the system may connect platform 210 to advertising servers 206. In one example, the components of network entity 202 may be part of a system to select a low performance ranked advertisement for display on network location 220.

Network entity 202 may receive instructions from client programs. Client programs may include an application or system that accesses a remote service on another computer system by way of network 250. These client programs may include a browser such as the Internet Explore™ browser distributed by Microsoft Corporation of Redmond, Wash., Netscape's Navigator™ browser, the Mozilla™ browser, a wireless application protocol enabled browser in the case of a cellular phone, a PDA, or other wireless device. User entity 220 may control a client machine 222 and the browser may execute on client machine 222 to access network entity 202 for receipt of content page 260 via a network 250. Content page 260 may be an example network location. Other examples of networks that a client may utilize to access network entity 202 may include a wide area network (WAN), a local area network (LAN), a wireless network (e.g., a cellular network), a virtual private network (VPN), the Plain Old Telephone Service (POTS) network, or other known networks.

In one example, users or agents of the users may access a publisher over a network and request a webpage populated with content information. Generally, the system may present the content information to the user in a variety of formats, such as, for example, text, images, video, audio, animation, program code, data structures, hyperlinks, and other formats. The content may be typically presented as a webpage and may be formatted according to the Hypertext Markup Language (HTML), the Extensible Markup Language (XML), the Standard Generalized Markup Language (SGML), or any other known language.

In response to the request for a webpage populated with content information, the publisher may transmit the requested webpage content information to the user for display on the user's machine. At or about the same time, the system may transmit a JavaScript call routine or a Hypertext Transfer Protocol (HTTP) call routine to the entity to request advertisements for insertion into the webpage. This may occur while the user's machine prepares to display the webpage. The call routine may reside in or be embedded onto the webpage. The insertion may be via an iframe mechanism, or JavaScript, or any other known embedding mechanism. In one example, the request for advertisements contains the Uniform Resource Locator (URL) of the webpage and additional data related to the webpage.

In an alternate example, upon receipt of the webpage request, the publisher may access the entity to request advertisements for insertion into the webpage prior to display of the webpage on the client machine associated with the user. The entity may receive the advertising request and the webpage information and analyzes the site and page content in real-time to construct a site summary and a page summary, respectively. The entity may assign initial or preliminary weights to the features in the page summary as an initial importance of each feature.

Other entities such as, for example, publisher entities 240 and advertiser entities 240, may access network entity 202 through network 250. Publisher entities 230 may communicate with both web servers 204 and user entities 230 to populate webpages 260 with appropriate content information 262 and to display webpages 260 for users 220 on their respective client machines 222. Publishers 230 may be the owners of webpages 260, and each webpage 260 may receive and display advertisements 264. Publishers 230 typically may aim to maximize advertising revenue while providing a positive user experience. Publisher entities 230 may include website that has inventory to receive delivery of advertisements, including messages and communication forms used to help sell products and services. The publisher's website may display a website may have webpages and advertisements. Visitors or users 220 may include those individuals that access webpages through use of a browser.

Advertiser entities 240 may communicate with web servers 204 and advertising servers 206 to transmit advertisements for display as ads 264 in those webpages 260 requested by users 220. Online advertisements may be communication devices used to help sell products and services through network 250. Advertiser entities 240 may supply the ads in specific temporal and thematic campaigns and typically may try to promote products and services during those campaigns.

Advertisers 240 may annotate their contextual advertisements with one or more bid phrases, owing to the system used for sponsored search advertising. However, the bid phrase typically has no direct bearing on the ad placement in contextual advertising. Instead, the bid phrase may provide a concise description of the target ad audience, as determined by the advertiser. For this reason, the bid phrase may be an important feature for successful ad placement. In addition to the bid phrase, the displayed few lines of text included with a short title and a creative further may characterize advertisements. The industry typically refers to advertised webpage as the landing page and each advertisement may contain the URL of the landing page. The network location in the Uniform Resource Locator (URL) may be a unique name that identifies an Internet server. A URL network location may include two or more parts, separated by periods, and users entities 230 may refer to a URL network location as the host name and Internet address.

Network 250 may be an interconnection of computers through a cable or some type of wireless connection so they can communicate with one another. Network 250 may be part of a worldwide network of computer networks that may use common network protocols to facilitate data transmission. In one example, network 250 may be part of the Internet.

In regards to online marketing, contextual advertising involves four primary entities. Publishers 230 may own webpages 260 and may rent a small portion of a webpage 260 to advertisers 240. Advertisers 240 may supply advertisements, with goal of promoting products or services. Users 220 may visit webpage 260 interact with ads 264. Finally, advertising entity 202 may have a role in selecting the ads 264 for the given user 220 visiting a page 260.

Content 262 may include text, images, and other communicative devices. Content 262 may be separate from the structural design of webpage 260 or website 260, which may provide a framework into which content 262 may be inserted, and separate from the presentation of webpage 260 or website 260, which involves graphic design. A Content Management System may change and update content, rather than the structural or graphic design of webpage 260 or website 260.

A goal of a contextual advertising system 200 may be to place ads 264 related to content 262 of page 260 to provide a good experience for user 220. In turn, this good user experience may increase a likelihood that user 220 will click on one or more of the ads 264. Previous research into topical advertising has confirmed that displaying ads that are more relevant results in more ad clicks. Advertising system 200 may determine that ads 264 and user entity 200 have elements in common based on past click-through performance by users that may have similarities to user entity 200. Advertising system 200 may implement method 100 within advertising system 200 to display relevant advertisement while cultivating new high performing advertisements.

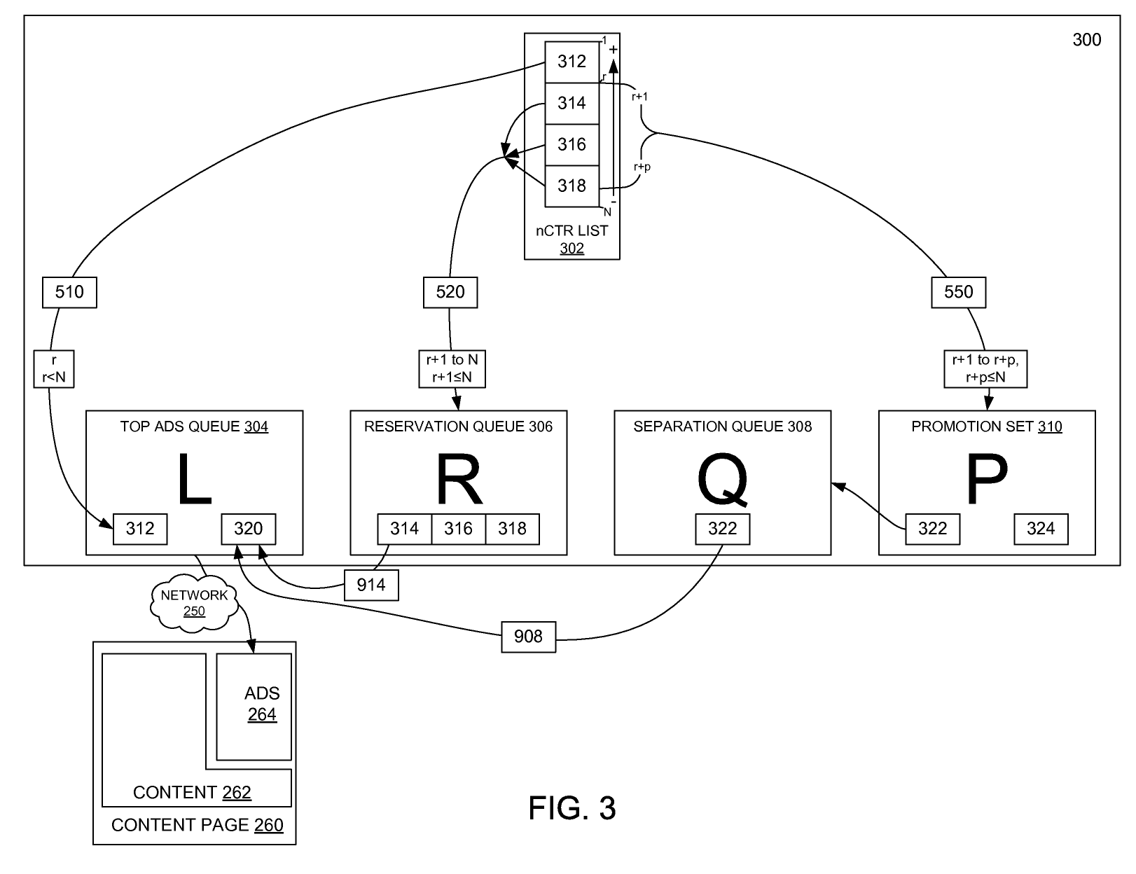

FIG. 3 is a block diagram illustrating an advertisement database 300. Advertisement database 300 may be a structure within network entity 202 that participates in method 100. For example, network entity 202 may position advertisement database 300 within data storage module 212 (FIG. 2) and access advertisement database 300 to select a low performance ranked advertisement for display on network location 220. Advertisement database 300 may include an nCTR list 302, a top ads queue L 304, a reservation queue R 306, a separation queue Q 308, and a promotion set P 310. Each may be in communication with the other databases and top ads queue 304 may be in communication with content page 260 through network 250.

nCTR list 302 may be a structured collection of records/data stored in network entity 202. nCTR list 302 may receive an output of processing block 110 in that nCTR list 302 may contain a group of N candidate advertisements ranked based on their nCTR score. Advertising system 200 may order the advertisements from a highest nCTR score, first positioned advertisement at a top of the list to a last, lowest n CTR score N positioned advertisement at a bottom of nCTR list 302.

Advertising system 200 may divide the advertisements within nCTR list 302 into tiers, such as a top, first tier 312, a second tier 314, and a third tier 316. First tier 312 may include r advertisements deemed as high performing advertisements. Advertising system 200 may display advertisements from first tier 312 on webpage 260 as advertisements 264. Second tier 314, and third tier 316 may include the remainder of N advertisements in that they may include advertisement r+1 through advertisement N. Advertising system 200 ultimately may display some advertisements from second tier 314, and third tier 316 on webpage 260 as advertisements 264.

The variable N may refer to the number of advertisements that advertising system 200 screened through various filtering, such as budget and account, to become an initial group of candidates for display on webpage 260. In practice, there may be about ten to thirty (N=[10, 30]) candidate advertisements. Typically, ten percent of these candidate advertisements (r=0.1*[10, 30]) may be high performing advertisements positioned within first tier 312. Second tier 314, and third tier 316 collectively may include the remaining (r+1, . . . , N) candidate advertisements.

Top ads queue 304 may be a structured collection of records/data stored as an L-list in network entity 202. Top ads queue 304 may include a collection of advertisements kept in order. A principal operation on the collection may be the addition of advertisements to a rear terminal position and removal of advertisements from a front terminal position. In addition to including advertisements from first tier 312, top ads queue 304 may include upranked advertisements 318. Upranked advertisements 318 may be non-first tier 312 advertisements that advertising system 200 promoted to be among those advertisements that advertising system 200 may display on webpage 260 as advertisements 264. Given a set of N advertising candidates {aᵢ}, advertising system 200 may generate top ads queue 304 as a ranked list that favors both high nCTR advertisements 312 and low confidence advertisements 318.

Reservation queue 306 may be a structured collection of records/data stored as an R-list in network entity 202. Reservation queue 306 may include a collection of advertisements kept in order. A principal operation on the collection may be the addition of advertisements to a rear terminal position and removal of advertisements from a front terminal position. Reservation queue 306 may include advertisements from nCTR list 302 not ranked as high performing advertisements. In an example, advertising system 200 may keep back and set aside advertisements from second tier 314, and third tier 316 for some future purpose by copying such advertisements from nCTR list 302 into reservation queue 306. For example, advertising system 200 may utilize reservation queue R 306 to control a tradeoff between exploration of low performing advertisements and exploitation of high performing advertisements.

Separation queue 308 may be a structured collection of records/data stored as a Q-list in network entity 202. Separation queue 308 may include a collection of advertisements kept in order. A principal operation on the collection may be the addition of advertisements to a rear terminal position and removal of advertisements from a front terminal position. Separation queue 308 may include certain advertisements transferred from promotion set 310. Promotion set 310 includes advertisements that advertising system 200 has not ranked as high performing advertisements and advertising system 200 may based their transfer from promotion set 310 to separation queue 308 on a nCTR confidence metric as discussed in more detail below. Advertising system 200 may include advertisements within separation queue 308 as advanced advertisements 320. Advertising system 200 may promote advanced advertisements 320 in rank relative to the original organizational advertisement hierarchy set out in nCTR list 302 and move them to top ads queue 304 based on the flip of a coin.

Promotion set 310 may be a structured collection of records/data stored as a P-set in network entity 202. Promotion set 310 may include a collection of advertisements that may not be kept in order. A principal operation on the collection may be the addition of advertisements to a rear terminal position and removal of advertisements from a front terminal position. Promotion set 310 may include certain advertisements from nCTR list 302 that advertising system 200 has not ranked as high performing advertisements. Advertising system 200 may divide advertisements within promotion set 310 into two groups: selected advertisements 320 that are move into separation queue 308 and non-selected advertisements 322 that remain within promotion set 310.

Promotion set 310 is larger than separation queue 308 to introduce some randomness. For example, advertising system 200 may only want to promote four ads (i.e., four ads for separation queue 308) but may consider eight ads for the opportunity (i.e., eight ads for promotion set 310). With a random process, advertising system 200 may determine which four ads eventually are promoted.

Processing Block 110

As noted, method 100 (FIG. 1) may rank a group of online advertisements at processing block 110. Advertising system 200 may place the ranked advertisements within nCTR list 302 (FIG. 3) according to their relative score. In one example, method 100 may present a group of advertisements, where advertising system 200 assigns a score to each advertisement in the group.

An advertisement impression may be a single appearance of an advertisement on a website that may result in one viewing of that advertisement by a single member of its audience. Advertising system 200 may deem that an ad impression (or ad view) has occurred when a user pulls up a webpage through a browser and the ad that advertising system 200 served to that page becomes visible within the computer monitor of the user. Advertising system 200 may identify a click as a depression of a button on a computer mouse and view a click through as a click onto an advertisement displayed on a webpage.

Advertising system 200 may base the score assigned to each advertisement on a performance of that advertisement, such as by taking into the account the number of impressions for that advertisement, the overall number of clicks received by that advertisement, and the number of clicks received by that advertisement by different persons. Advertising system 200 may take into account additional or different factors when determining each numerical score. In one example, method 100 may rank the group of advertisements utilizing an nCTR model.

The nCTR model utilized in advertising system 200 may be a performance-based advertisement ranking system that outputs a click feedback score (or nCTR score) for each evaluated advertisement. Advertising system 200 may utilize the click feedback score as a way to predict future CTRs based on actual past click feedbacks. The placement of a particular advertisement on a particular webpage may constitute a page-ad pair. Granularity may be the extent to which a system is broken down into small parts, either the system itself or its description or observation. In the nCTR model, advertising system 200 may maintain historical statistics of impressions, clicks, and ratios for each page-ad pair at various levels of granularity.

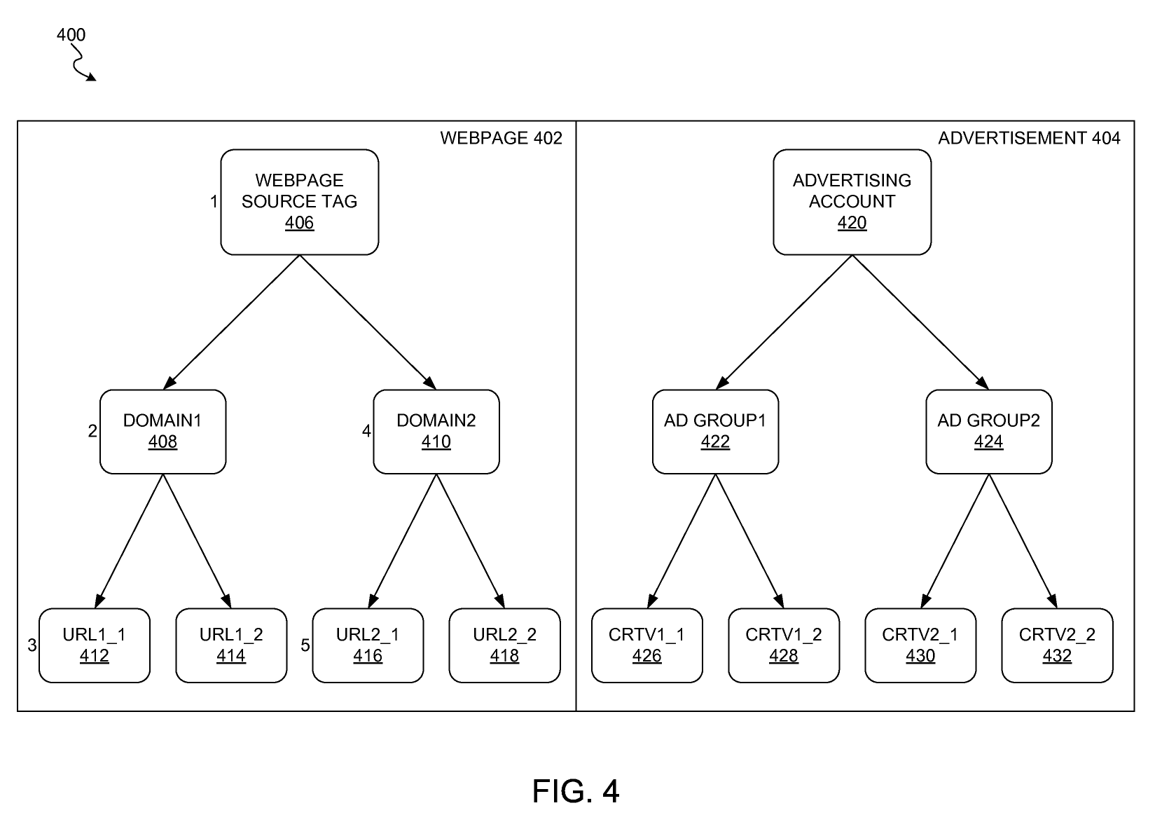

FIG. 4 is a block diagram illustrating levels of granularity for a page-ad pair 400. Page-ad pair 400 may include a webpage 402 and an advertisement 404, each of which may have a hierarchy based on space and time. In one example, webpage and advertisement pair 402-404 may have five separate aggregations, identified in FIG. 4 as 1-5.

Webpage 402 may have a source tag level 406, a domain1 level 408, a domain2 level 410, a URL1_1 level 412, a URL1_2 level 414, a URL2_1 level 416, and a URL2_2 level 418. Advertising system 200 may link domain1 level 408 and domain2 level 410 directly to and below source tag level 406. Advertising system 200 may link URL1_1 level 412 and URL1_2 level 414 directly to and below domain1 level 408. Further, advertising system 200 may link URL2_1 level 416 and URL2_2 level 418 directly to and below domain2 level 410.

Source tag level 406 may be a highest space level at which advertising system 200 may classify webpage 402. A source may be a data object (such as a table or view) that advertising system 200 uses as a source of data. Advertising system 200 may enclose each individual source in a source tag, where an event-source tag may define a source for events sent by a server. Advertising system 200 may utilize the source tag, for example, to specify multiple media sources for audio and video.

Domain1 level 408 and domain2 level 410 each may be a mid-space level at which advertising system 200 may classify webpage 402. Domain1 level 408 and domain2 level 410 each may represent a different domain name, where the domain name may be a common network name (e.g., example.com) under which a collection of network devices may be organized. In addition, the domain name may include an identification label that defines a realm of administrative autonomy, authority, or control in the Internet, based on the Domain Name System (DNS). The Domain Name System may be a hierarchical naming system for computers, services, or any resource connected to the Internet or a private network.

URL1_1 level 412, URL1_2 level 414, URL2_1 level 416, and URL2_2 level 418 each may be a lower space level at which advertising system 200 may classify webpage 402. Each Uniform Resource Locator (URL) may be a subset of a Uniform Resource Identifier (URI) that specifies a location at which an identified resource is available and the mechanism for retrieving it. Advertising system 200 may treat the URL as the address of a webpage on the World Wide Web.

Advertisement 402 may have an advertising account level 420, an ad group1 level 422, an ad group2 level 424, a CRTV1_1 level 426, CRTV1_2 level 428, CRTV2_1 level 430, and CRTV2_2 level 422. Advertising system 200 may link ad group1 level 422 and ad group2 level 424 directly to and below advertising account level 420. Advertising system 200 may link CRTV1_1 level 426 and CRTV1_2 level 428 directly to and below ad group1 level 422. Further, advertising system 200 may link CRTV2_1 level 430 and CRTV2_2 level 422 directly to and below ad group2 level 424.

Advertising account level 420 may be a named record representing a formal contractual relationship established between network entity 202 and advertiser 240. The formal contractual relationship may require advertising system 200 to utilize advertisements from advertiser 240 in providing advertising services. Advertising account level 420 may be reflective of a particular advertising campaign. An advertising campaign may be a series of advertisement messages that share a single idea and champion theme which make up an integrated marketing communication (IMC) that uses a central message communicated in the promotional activities.

Ad group1 level 422 and ad group2 level 424 each may be part of an advertising campaign. Each ad group 422, 424 may contain keywords and advertisements. In other words, an ad group may be a compilation of ads and related keywords that an advertiser defines for a specific advertisement campaign. CRTV1_1 level 426, CRTV1_2 level 428, CRTV2_1 level 430, CRTV2_2 level 422 each may include creatives (CRTVs). These creatives may include ad text shown on webpages, such as a title, a short description, and a display URL.

The click-through rate (CTR) of an advertisement for a given space or location within the Internet may depart from statistical expectations. Advertising system 200 may utilize the hierarchical structure illustrated in FIG. 4 to get a daily CTR variance for each aggregation level down to url-crtv level. Rather than break down the url-crtv level into a fine space resolution, advertising system 200 further may divide each combination by time (daily, weekly, monthly) to get various space and time CTR variance. As discussed in more detail below, advertising system 200 may aggregate the various space and time variances to calculate beta-binomial distribution α and β parameters that utilize both the mean (average) click-through rate and the variance of the click-through rate for page-ad pairs.

In general, when semantic features are less effective in describing webpage-advertisement similarity, advertising system 200 may utilize a performance-based advertisement ranking system to predict future click-through rates based on past click feedbacks. As noted, advertising system 200 may maintain historical statistics of impressions, clicks, and ratios for each page-ad pair at various levels of granularity. Advertising system 200 may update these statistics everyday with a decay function to combine the daily counts with previous ones with a one parameter exponential smooth formula. If advertising system 200 determines that an impression of a particular aggregation is less than a predetermined threshold, advertising system 200 may consider that impression too sparse and ignore that impression. In this case, advertising system 200 may utilize default values for the impression, click, and ratio of that advertisement. Advertising system 200 may utilize these numbers as features to calculate the nCTR score from a logistic regression model trained offline. Advertising system 200 then may use this nCTR score for advertisement ranking.

Advertising system 200 may predict a probability of click (CTR) using as features the historical impressions, clicks, and CTR of aggregations at multiple resolutions. The click feedback scores (nCTR scores) may reflect a gathering of statistics from cross product of attributes in publisher, advertiser, user and accumulate historical impression and click statistics at various levels of granularity, such as by using 100% of daily traffic. Under the nCTR model, advertising system 200 may use aggregate click and impression statistics for page-ad pairs as predictors of click propensity. Advertising system 200 may combine nCTR model prediction with ad-ranking models to optimize click-through rate predictions. The nCTR may adapt ad-ranking models dynamically. In addition, the multi-resolution aggregations of the nCTR model may capture high and low traffic patterns and use immediate click feedback and frequent statistical updates to optimize click-through rate prediction.

Under the principle of maximum entropy (MaxEnt), a probability distribution that best represents a current state of knowledge is the one with largest entropy. In addition, a logistic regression is a statistical model that a system may use for a process that contains an exponential factor to see what the best fit of the data is. By fitting data to a logistic curve, logistic regression may predict the probability of occurrence of an event.

In one example, advertising system 200 may determine nCTR scores by using a logistic regression (MaxEnt) model to fit the data to a logistic curve according to equation (1):

p(click|(I,C,R))^{∝} exp(z₀+z_{I}I+W_{C}C+z_{R}R) (1)

where
I is the number of impressions,
C is the number of clocks,
R is the click-through rate (CTR),
z is a Lagrange multiplier to find a maximum/minimum of a function subject to constraints, and
p(click|(I,C,R)) is the nCTR score proportional to the exponential of the quantity shown.
   Once advertising system 200 utilizes equation (1) to provide the nCTR scores, method 100 may rank the group of advertisements at processing block 110. In one example, advertising system 200 may rank the advertisements from highest score to lowest score using a predetermined metric. For example, advertising system 200 may sort the advertisements based on nCTR scores according to the equation

a₁>a₂> . . . >a_{N} (2)

where
N is the number of advertisements that advertising system 200 screened through various filtering, such as budget and account, to become an initial group of candidates for display on webpage 260, and
a_{N} is the nCTR score of an advertisement a in position N.

Processing Block 120

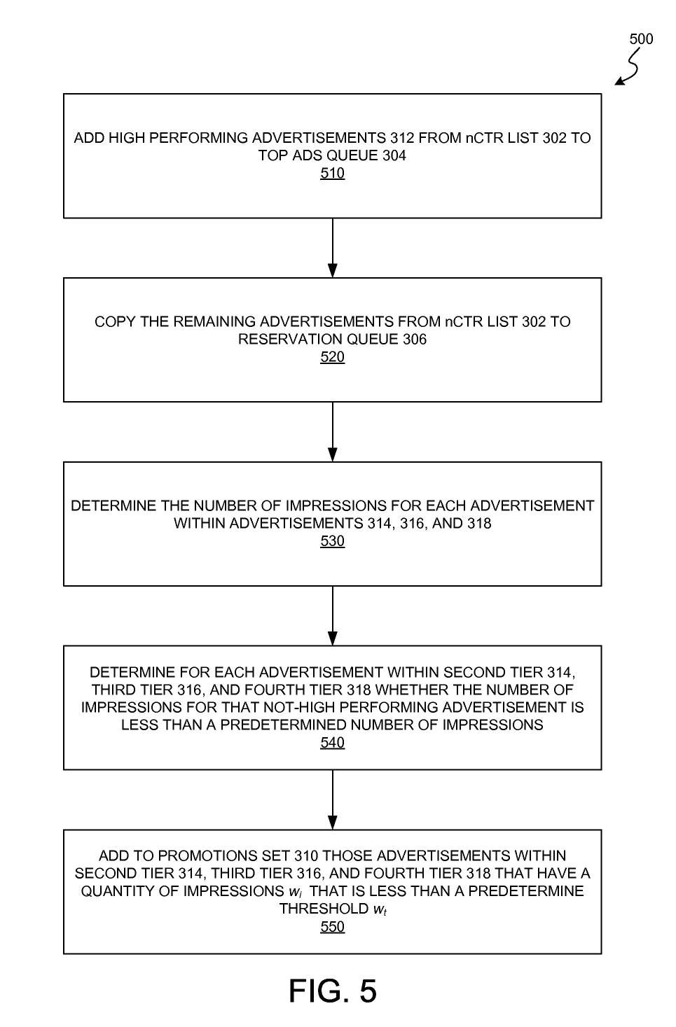

FIG. 5 is a flow diagram illustrating a method 500 to divide a group of advertisements into a first list, a second list, and a promotion set at processing block 120. In an example, advertising system 200 initially may position the group of advertisements within nCTR list 302 (FIG. 3) per processing block 110 (FIG. 1). Top ads queue 304 may represent a first list L, reservation queue 306 may represent a second list R, separation queue 308 may represent a third list Q, and promotion set 310 may represent a promotion set P. Advertising system 200 may present method 500 with a set of N advertising candidates {aᵢ}, where the first list, the second list, the third list, and the promotion set initially may be empty.

At processing block 510, method 500 may add high performing advertisements 312 from nCTR list 302 to top ads queue 304. Advertising system 200 may code processing block 510 using logic such as for i=1 to r, add aᵢ to top ads queue 304, where r represents a predetermined number of high performing advertisements and r<N. In one example, advertising system 200 may deem the top ten percent of N advertisements in nCTR list 302 as having above average advertisement click-through rates. In other words, r=(N)(0.1) in one example.

At processing block 520, method 500 may copy the remaining advertisements from nCTR list 302 to reservation queue 306. In other words, method 500 may copy into reservation queue 306 all advertisements from nCTR list 302 that are not high performing r advertisements within first tier 312. Advertising system 200 may code processing block 520 using logic such as for i=r+1 to N, add aᵢ to reservation queue 306. Here, method 500 may preserve as a separate set those advertisements 314 and 316 not deemed as high performing advertisements relative to other advertisements in nCTR list 302.

At processing block 530, method 500 may determine the number of impressions for each advertisement within advertisements 314. The number of impressions may be available from that information used to calculate the nCTR scores. Here, advertising system 200 may ensure that each advertisement's number of impressions is link to that advertisement.

At processing block 540, method 500 may determine, for each advertisement within second tier 314, whether the number of impressions for that not-high performing advertisement is less than a predetermined number of impressions. Here, method 500 is looking for those not-high performing advertisements that advertising system 200 has not given a sufficient chance to prove themselves before the viewing public. These advertisements may come from anywhere within second tier 314. If method 500 determines that the number of impressions for a not-high performing advertisement is less than a predetermined number of impressions, then method 500 may proceed to processing block 550.

At processing block 550, method 500 may add to promotion set 310 those advertisements within second tier 314 that have a quantity of impressions imp, that is less than a predetermine threshold impₜ. Advertising system 200 may code processing block 550 using logic such for i=r+1 to N and impᵢ<impₜ, add aᵢ to promotion set 310. Note that if the impression of an advertisement is above the threshold impₜ, advertising system 200 will ignore that advertisement and not add it to promotion set 310.

In an example, advertising system 200 may limit the number of advertisements processed at processing block 550 using a control knob variable p. In this example, advertising system 200 may code processing block 550 using logic such for i=r+1 to r+p, and impᵢ<impₜ, where p is the number of ads in promotion set 310 and r+p≦N, add aᵢ to promotion set 310. Here, advertising system 200 may require that the advertisement be above a certain nCTR score threshold before advertising system 200 gives that advertisement a chance at upranking through promotion set 310.

Processing Block 130

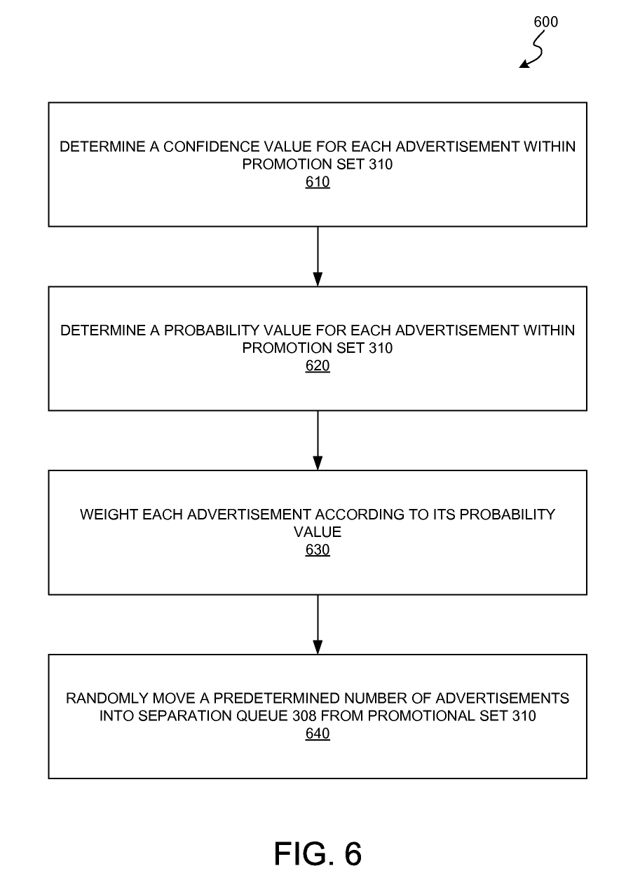

FIG. 6 is a flow diagram illustrating a method 600 to utilize a confidence metric to select an advertisement randomly within promotion set 310 to move from promotion set 310 to separation queue 308. In general, advertising system 200 may determine a confidence value for each advertisement, translate that confidence value into a probability value, and weight each advertisement according to its probability value. Advertising system 200 then may select a predetermined number (q) of advertisements randomly from promotional set 310 using the weighted chances for each advertisement.

Processing Block 130: Confidence Value Determination

At processing block 610, method 600 may determine a confidence value (C₁ or C₂) for each advertisement within promotion set 310. The numerical confidence value may reflect a level of assuredness by advertising system 200 in the nCTR score for a given advertisement within promotion set 310. In general, the more doubt advertising system 200 has in the nCTR score for a given advertisement, the more likely that advertisement should be upranked among its peers.

Advertising system 200 may determine an advertisement confidence value through one of two types of measurements. Advertising system 200 may use these two metrics to measure the confidence of the nCTR score. In the first measurement, advertising system 200 may determine an advertisement confidence value C₁ using historical low count impressions to make a point estimation. In the second measurement, advertising system 200 may determine an advertisement confidence value C₂ through the statistical distribution of the click-through rate (CTR) for that advertisement, even for advertisements with a high number of impressions.

For advertisement confidence value C₁, advertising system 200 applies the concept that, the more impressions that an advertisement has, the more reliable its empirical or observed CTR estimation is. In this regard, advertising system 200 may determine the advertisement confidence value as the hyperbolic tangent of a hyperbolic angle, where the hyperbolic angle may be determined by dividing the average number of impressions over multiple aggregations by the number of multiple aggregations. In an example, advertising system 200 may determine the advertisement confidence value C₁ according to equation (3):

C₁=tan h(imp/b) (3)

where
imp is the average number of impressions,
b is a predetermined number of aggregations in that the b parameter may be the parameter that controls how much historical data may be needed to trust the nCTR score,
tan h is the hyperbolic tangent function, and
C₁ is an advertisement confidence value for a given advertisement.

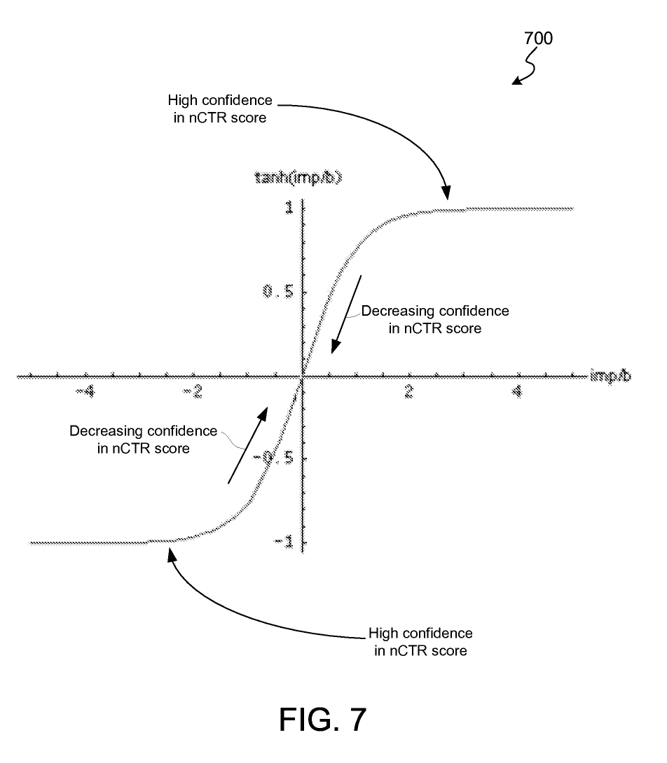

FIG. 7 is an example plot 700 of tan h function C₁=tan h(imp/b) with the hyperbolic angle imp/b on the x-axis and the confidence value C₁ on the y-axis. Here, when the average number of impressions imp decreases with respect to number of aggregations b, the confidence of advertising system 200 in the nCTR score decreases. If the average number of impressions imp is zero for a given advertisement, then advertising system 200 will have zero confidence in the nCTR score derived for that advertisement. As the average number of impressions imp increases, the confidence of advertising system 200 in the nCTR score increases and eventually approaches 100%. A plot of equation (3) may vary between a ramp function and a step function. In FIG. 7, the number of impressions is always non-negative and the left side of the function is not used.

As noted, advertising system 200 may determine an advertisement confidence value C₂ through the statistical distribution of the click-through rate (CTR) for that advertisement. As a more sophisticated technique than primarily using historical impressions in a point estimation, advertising system 200 may apply a variance based metric to model the statistical distribution of CTR to take into account how empirical CTR changes over time and space. In this regard, there may be a negative correlation between the variance of the distribution and the confidence in nCTR. Here, a high variance indicates a more spread-out empirical CTR distribution and makes nCTR less reliable.

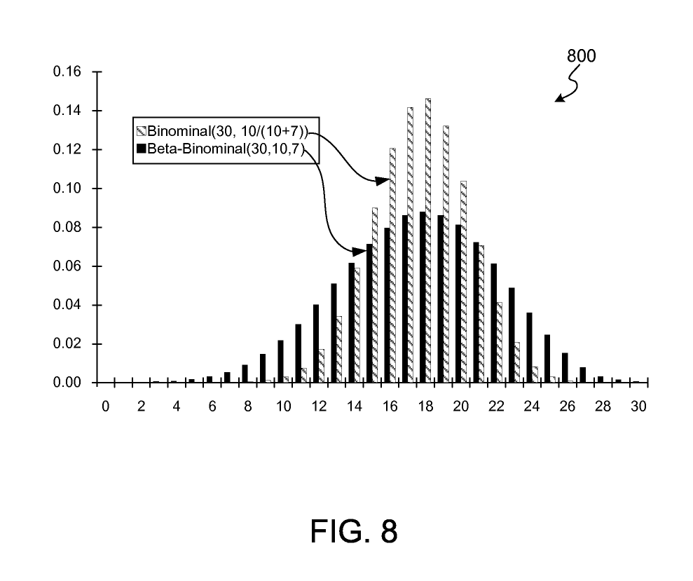

FIG. 8 illustrates an example beta-binomial (n=30, α=10, β=7) distribution 800, together with its best matching binomial distribution. In Bayesian statistics, the posterior distribution (posterior probability) of a random event or an uncertain proposition is the conditional probability that is assigned after the relevant evidence is taken into account. Without a Beta prior, advertising system 200 cannot estimate a posterior distribution for the CTR. Here, advertising system 200 may utilize a beta-binomial distribution and the Beta prior is for the CTR.

A beta-binomial distribution may be used to model the number of successes in n binomial trials when the probability of success p is a beta(α, β) random variable. A beta-binomial distribution returns a discrete value between 0 and n. The extreme flexibility of the shape of the beta distribution means that it is often a very fair representation of the randomness of p. While the probability of success varies randomly, that probability applies to all trials in any one scenario. The beta-binomial distribution always has more spread (variance) than its best fitting binomial distribution, because the beta distribution adds extra randomness. Beta distribution may be used to model CTR distribution since it reasonable to model click as binomial distribution and because Beta distribution is a conjugate prior of binomial distribution.

To determine advertisement confidence value C₂, advertising system 200 may assume that the number of clicks for any page-ad pair 400 (FIG. 4) follows a beta-binomial distribution, such as in FIG. 8. Advertising system 200 also may estimate its conjugate prior from means and variances of the number of clicks at different time periods as well as different levels of granularity. Conditioned on the observed numbers of impressions and clicks, advertising system 200 then may calculate the posterior distribution. The posterior distribution or posterior probability of a random event or an uncertain proposition is the conditional probability that advertising system 200 may assign to reflect updated knowledge after taking into account relevant evidence. Higher variance of the posterior distribution may correspond to lower confidence in the nCTR score.

A Bernoulli trial is a single experiment whose event outcome is random and can be of two possible outcomes, “success,” and “failure.” In the case of flipping a coin, a system may phrase these events into a “yes or no” question such as, “Did the coin land heads?”. For each page-ad impression, advertising system 200 may think of that impression as a Bernoulli trial, where the probability for click is CTR (θ). Here, the number of clicks (K—upper case “K”) in a sequence of n impressions follows a binomial distribution

K˜B(n, θ) (4)

where

P(K=k|n, θ)=θ^{k}(1−θ)^{n-k}n!/k!(n−k)!. (5)

The beta distribution is a family of continuous probability distributions defined on the interval [0, 1] parameterized by two positive shape parameters, typically denoted by α and β. Advertising system 200 may assume a beta prior for θ, which may be conjugate to the binomial distribution

π(θ|α, β)˜Beta(α, β)=θ^{α-1}(1−θ)^{β-1}/B(α, β). (6)

As the CTR of a page-ad pair, advertising system 200 assumes that θ follows the Beta distribution of equation (6) above. In equation (6), α and β are parameters learned offline from (page, ads) serv/click events and B(α, β) is the Beta function. The probability of an advertisement being selected for exploration is Prob(page, ad), which equals the function of the variance of the posterior. The posterior distribution of 0 conditioned on observed impressions (n) and clicks (k) still is a beta distribution

P(θ|α, β, n, k)˜Beta(α+k, β+n−k). (7)

Advertising system 2000 may calculate the variance of the beta distribution of equation (7) once advertising system 200 receives the parameters.

Advertising system 200 may estimate the prior α and β from historical data. Given a set of samples {x₁, x₂, . . . , x_{N}} drawn from Beta(α, β), advertising system 200 may estimate its parameters by maximizing the data likelihood

P(x₁, x₂, . . . , x_{N}|α, β). (8)

The reference Statistical Models in Engineering, by Gerald Hahn and Samuel Shapiro, John Wiley & Sons, page 95, 1994 provides details on estimate the prior α and β parameters by maximizing the data likelihood and this discussion incorporates the Statistical Models in Engineering information herein by reference.

For advertisement confidence value C₂, advertising system 200 use five sets and considers samples expanded in both time and space dimensions. The five sets may include (i) Page URL and advertisement creative from different days, (ii) Page URL and advertisement group, (iii) Page URL and advertisement account, (iv) Page domain and advertisement group, and (v) Page source tag and advertisement group. From each of these five sets, advertising system 200 may estimate one parameter value. Advertising system 200 may combine each estimate parameter value as the final α and β parameters. After that, advertising system 200 may calculate a reverse confidence score as

C₂=Variance(P(θ|α, β, n, k)) (9)

where
α, β are two positive shape parameters that parameterize a continuous probability distribution defined on the interval [0, 1],
n is the number of observed impressions made by an advertisement,
k is the number of observed click-throughs received by an advertisement (both n and k refer to a page ad pair),
θ is a click-through rate (CTR) of a given page-ad pair and is a random variable that corresponds to an underlying CTR for a page ad pair,
P(θ|α, β, n, k) is a posterior distribution of a CTR given a prior Beta (alpha, beta) and the observations n and k,
Variance of a random variable or distribution (P(θ|α, β, n, k)) is the expected square deviation of that variable from its expected value or mean as a measure of the amount of variation of all the scores for a variable (not just the extremes which give the range), and
C₂ is an advertisement confidence value for a given advertisement.

Processing Block 130 (Cont.)

After advertising system 200 determines at processing block 610 a confidence value (C₁ or C₂) for each advertisement within promotion set 310, method 600 may determine a probability value for each advertisement at processing block 620. Advertising system 200 may utilize either confidence value (C₁ or C₂) to determine the probability value of each advertisement within promotion set 310.

When advertisement confidence value C₁ is applied, advertising system 200 may determine the probability value for an advertisement aⱼ in the promotion set 310 as

probability value=1−aⱼ·C₁/Σₘaₘ·C₁ (10)

where
C₁ is an advertisement confidence value for a given advertisement.
m is the number of advertisements in the promotion set 310 or a number of advertisements in the promotion set 310 that is less than or equal to the number of advertisements in the promotion set 310,
aⱼ·C₁ is the C₁ score for advertisement aⱼ, where aⱼ is a certain j position advertisement in promotion set 310,
Σ is a large upright capital Sigma used as a summation symbol
Σₘaₘ·C₁ is the addition of the C₁ scores for all advertisements aₘ in promotion set 310 to allow normalization.

When advertisement confidence value C₂ is applied, advertising system 200 may determine the probability value for an advertisement aⱼ as

probability value=aⱼ·C₂/Σₘaₘ·C₂ (11)

where
C₂ is an advertisement confidence value for a given advertisement.
m is the number of advertisements in the promotion set 310 or a number of advertisements in the promotion set 310 that is less than or equal to the number of advertisements in the promotion set 310,
aⱼ·C₂ is the C₂ score for advertisement aⱼ, where aⱼ is a certain j position advertisement in promotion set 310,
Σ is a large upright capital Sigma used as a summation symbol
Σₘaₘ·C₂ is the addition of the C₂ scores for all advertisements aₘ in promotion set 310 to allow normalization.

With a probability value for each advertisement within promotion set 310 determined at processing block 620, method 600 may weight each advertisement according to its probability value at processing block 630. Rather than give each advertisement within promotion set 310 an equal chance of being upranked, method 600 may weight each advertisement according to its probability value to skew the selection towards those advertisements whose nCTR scores are rebutted by lower confidence in those scores.

At processing block 640, method 600 randomly may move a predetermined number (q) of advertisements into separation queue 308 from promotional set 310 using the weighted chances for each advertisement. Promotional set P 310 only contains p ads and the elements in this set need not be ordered. In an example, where p=10 and q=5, method 600 may select five advertisements (q=5) from the ten advertisements (p=10) in promotional set 310 and move those advertisements 320 from promotional set P 310 to separation queue 308. Advertising system 200 may select the five q advertisements by chance. The probability value for each advertisement may cause an unequal chance of advertising system 200 selecting that advertisement.

Advertising system 200 may code processing block 640 using logic such as for j=1 to q, randomly pick aⱼ from promotional set P 310 as weighted by probability value=1−aⱼ·C₁/Σₖaₖ·C₁ or probability value=aⱼ·C₂/Σₖaₖ·C₂. In adding aⱼ to separation queue Q 308 as a selected advertisement 320, advertising system 200 removes aⱼ from promotional set P 310, leaving behind non-selected advertisements 322.

As noted, the probability value has an effect of skewing the chance of advertising system 200 selecting an advertisement for upranking In other words, the lower confidence advertising system 200 has in the nCTR score of a particular advertisement, the higher its probability value. In turn, the higher its probability value, the more likely that advertising system 200 will select the advertisement for placement near the head of top ads queue 304 in an unequal chance, random selection.

Processing Block 140

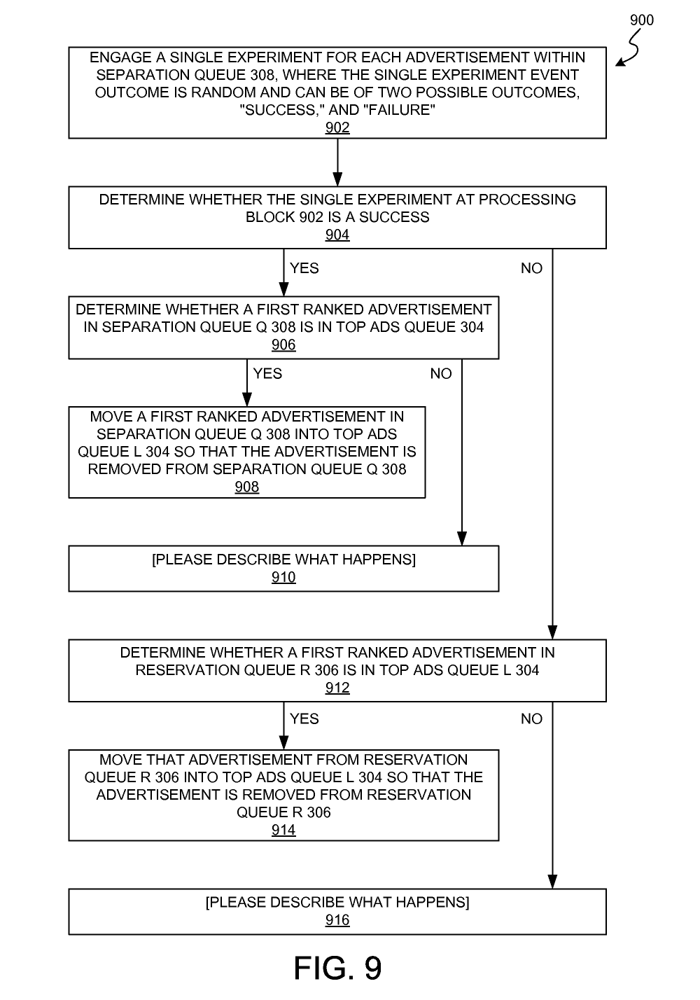

FIG. 9 is a flow diagram illustrating a method 900 to move an advertisement within the third list or the second list to the first list. Here, method 900 may provide a process by which advertising system 200 may move advertisements within separation queue 308 and within reservation queue 306 to top ads queue 304. In sum of method 900, for i=r+1 to N, advertising system 200 may flip a coin with a probability of s for heads. If advertising system 200 get a head, add the first element in Q that may be not already in L to L and remove it from Q; else, add the first element in R that may be not already in L to L and remove it from R. Here, advertising system 200 may merge some advertisements that were in the promotional queue and a remaining of the original nCTR list 302 to form a new ranked list 318 within top ads queue 304. In this way, advertising system 200 may give advertisements in the promotional queue additional chances at a rank that is higher relative to their original positions within nCTR list 302.

At processing block 902, method 900 may engage a single experiment for each advertisement within separation queue 308, where the single experiment event outcome is random and can be of two possible outcomes, “success,” and “failure.” For example, method 900 may flip a two-sided coin having a head side and a tail side, where the coin has a predetermined probability for landing on the head side. Advertising system 200 may bias the outcome by utilizing a predetermined probability s for success. In one example, s may be set to 0.50. In another example, s may be set to 0.90.

At processing block 904, method 900 may determine whether the single experiment at processing block 902 is a success. For example, method 900 may answer the question, “Did the coin land heads?”. If method 900 determines that the single experiment is a success (e.g., coin lands on heads), method 900 may proceed to processing block 906. If method 900 determines that the single experiment is not a success (e.g., coin lands on tails), method 900 may proceed to processing block 914.

At processing block 906, method 900 may determine whether a first ranked advertisement in separation queue Q 308 is in top ads queue 304. If method 900 determines that a first ranked advertisement in separation queue Q 308 is not in top ads queue L 304, then method 900 may move a first ranked advertisement in separation queue Q 308 into top ads queue L 304 at processing block 908 so that advertising system 200 removes the advertisement from separation queue Q 308. If method 900 determines at processing block 906 that a first ranked advertisement in separation queue Q 308 is in top ads queue L 304, then remove the first ranked advertisement in separation queue Q 308 from separation queue Q 308 at processing block 910.

From both processing block 908 and processing block 910, method 900 may proceed to processing block 912. At processing block 912, method 900 may add all the remaining ads in the reservation pool 306 to the top ads queue 304 after all ads in separation queue 308 have been processed at processing block 902. Thus, at processing block 912, method 900 may determine whether a single experiment has been performed for each advertisement within separation queue Q 308. If a single experiment has not been performed for each advertisement within separation queue Q 308, then method 900 may return to processing block 902. If a single experiment has been performed for each advertisement within separation queue Q 308, then method 900 may proceed to processing block 914.

At processing block 914, method 900 may determine whether a first ranked advertisement in reservation queue R 306 is in top ads queue L 304. If method 900 determines that a first ranked advertisement in reservation queue R 306 is not in top ads queue L 304, then method 900 may move that advertisement from reservation queue R 306 into top ads queue L 304 at processing block 916 so that advertising system 200 removes the advertisement from reservation queue R 306. If method 900 determines at processing block 914 that a first ranked advertisement in reservation queue R 306 is not in top ads queue L 304, then method 900 may then remove the first ranked advertisement in reservation queue R 306 from reservation queue R 306 at processing block 918.

In advertising system 200, advertisements in separation queue 308 are low-confidence ads and only advertisements in separation queue 308 have the chance to be upranked. Advertisements within reservation queue R 306 are sorted by the nCTR score. Thus, a best situation for advertisements in reservation queue R 306 is to maintain their original positions. In other words, if an advertisement is not in separation queue 308, a position of that advertisement in the final ranking list is lower than all advertisements with higher nCTR scores. While advertisement system 200 theoretically may display a proven-low-performance ad on a webpage, this may occur only after all other advertisements have low performance and advertisement system 200 is not able to promote low confidence advertisements because of randomness. Such a happening is very unlikely and does not affect the optimization of the system.

Processing Block 150

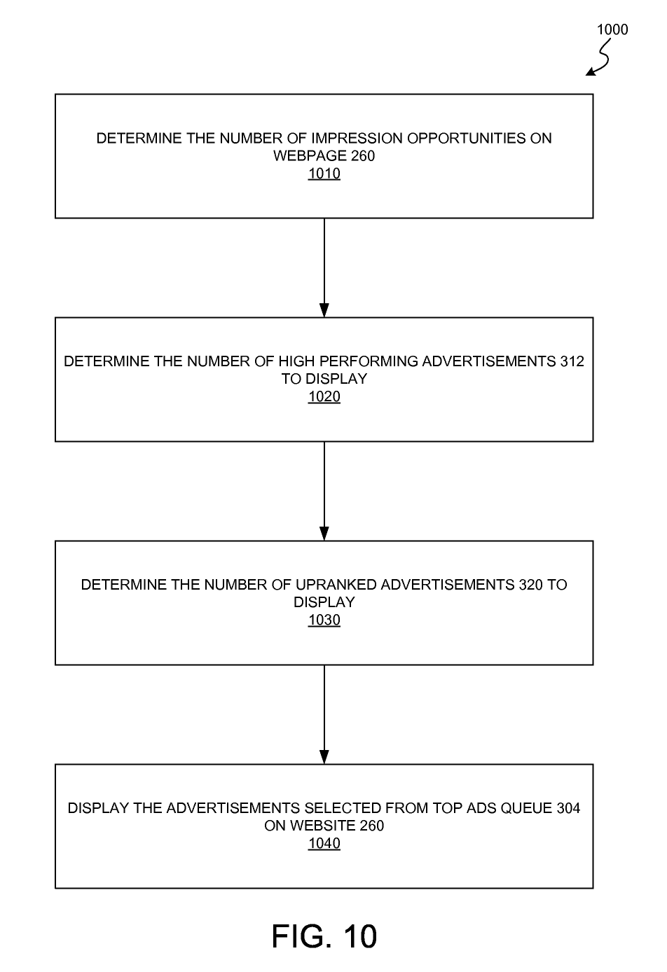

FIG. 10 is a flow diagram illustrating a method 1000 to display advertisements 312 and 318 within top ads queue 304 on webpage 260 as ads 264. Advertising system 200 may utilize method 1000 to display the top advertisements within the first list on a webpage at processing block 150 of FIG. 1. In deciding which advertisements within top ads queue 304, advertising system 200 may take into account several factors. For example, advertising system 200 may based the decisions on the number of available ad spaces within webpage 260 (e.g., the number of advertising impression opportunities), the amount of high performing advertisements 312 needed to maintain a predetermined revenue stream, and the amount of upranked advertisements 318 needed to ensure a refreshed and rejuvenated stockpile of high performing advertisements.

At processing block 1010, method 1000 may determine the number of impression opportunities on webpage 260. Typically, a display of a webpage may carry with it anywhere from one to six positions that advertising system 200 may fill with an advertisement. The number of impression opportunities on webpage 260 may be available to advertising system 200 as part of the initial request for content page 260 by user 220.

At processing block 1020, method 1000 may determine the number of high performing advertisements 312 that advertising system 200 needs to display at a given moment in time to maintain a predetermined revenue stream. Each click on an advertisement may bring in a certain amount of revenue, typically around US$0.01. Overtime, advertising system 200 may determine that the display of so many advertisements over a given period should bring in an approximate amount of revenue. The advertising revenue rate may be determined on a per-minute, hourly, daily, weekly, and monthly basis. As the revenue stream falls below a predetermined desired amount, advertising system 200 may increase the number of displayed high performing advertisements 312. As the revenue stream rises beyond a predetermined desired amount, advertising system 200 may decrease the number of displayed high performing advertisements 312 to increase the number of displayed upranked advertisements 318.

At processing block 1030, method 1000 may determine the number of upranked advertisements 318 that advertising system 200 may display at a given moment in time. In general, the number of upranked advertisements 318 that advertising system 200 may display at a given moment in time may be determined by subtracting the number of high performing advertisements 312 selected for display from the total number of advertising spaces available on webpage 260. In an example, advertising system 200 may select two high performing advertisements 312 and four upranked advertisements 318 for display on webpage 260 to fill six advertising spaces available on webpage 260. Advertising system 200 may base its selection of a particular high performing advertisement 312 and upranked advertisement 318 for display on the nCTR score of the advertisement.

Advertising system 200 may consider a single appearance of advertisement 264 on webpage 260 as an advertisement impression. Some companies 202 may transact as many as twenty billion advertisement impressions per day. Thus, there is significant opportunity through out a day to display upranked advertisements 318 to give them a chance to prove themselves as high performing advertisements. At times, advertising system 200 may determine that it has compiled as a set a sufficient number of high performing advertisements. Under such circumstances, advertising system 200 may display less upranked advertisement 318 than determined by the above simple subtraction. This may allow advertising system 200 to increase its advertising revenue stream while ensuring that advertising system 200 is elevating enough upranked advertisements 318 to high performing advertisements through public advertising displays.

At processing block 1040, method 1000 may display top advertisements selected from the final ranked list L 304 on the page 260. The selection may result in some advertisements in the final ranked list L 304 not being displayed. To display the advertisements advertising system 200 may map advertisements 264 and content 262 into a data package. Advertising system 200 then may transmit that data package from network entity 202 to client machine 222. As a point of reference, method 100 may take microseconds from a request by user 220 for content page 260, through the selection of advertisements 264, to the delivery of content page 260.

Method 100 Experiments

In an advertising system that relies on an nCTR model, advertisements with large numbers of impressions and high CTRs are always favored. By repeatedly displaying a small group of ads, the advertising system quickly may run out the advertising budgets of advertisers. When that happens, the advertising system may find it difficult to select relevant advertisements since the system then will not have reliable estimation for the performance of the remaining ads. Advertising systems that utilize a performance-scoring model to select advertisements may benefit from an exploration and exploitation mechanism to discover more high performance advertisements while preserving revenue. Increasing the diversity of the advertisement pool also reduces the risk for user fatigue.

Advertising system 200 may give low-performing advertisements a transient rank boost as a way to explore the performance of that advertisement in front of an online audience. The exploration and exploitation (EE) algorithm of method 100 utilizes confidence measurements to display not only high performance ads, but also low confidence ads. In this way, advertising system 200 gives opportunities to advertisements that are not fully tested, especially new ads. Importantly, method 100 includes multiple knobs (b, imp, N, r, p, z, q, s) that flexibly allows users to control how advertisements are explored taking into account business and technical factors. In other words, these sensitivity knobs allow method 100 to control the budge allocation between exploration and exploitation. For example, the parameter s controls how much favor advertising system 200 assigns to advertisements within separation queue 308. In addition, advertising system 200 may decide the number of advertisements to reserve (r), the lowest possible rank to be considered for exploration (r+p), the number of advertisements to explore (q), and the likelihood they are promoted (s).

Bucket testing is a methodology that an advertising system may use to gauge an impact of a new system on metrics of the advertising system. A basic premise is to run two simultaneous versions of the advertising system to measure differences in metrics between the two systems, such as clicks, traffic, and transactions. Bucket testing provides a positive, covert way to send a small, random amount of traffic (usually less than 5%) to a different user interface without negatively affecting a bottom line of the running system through unintended negative consequences.

One immediate benefit of advertisements exploration through method 100 may be to expand the advertisement pool. As detailed in the below bucket test results, advertising system 200 experienced significant increase in the number of unique advertisements while maintaining the same level of exposure to good performers. In addition, the coverage of the nCTR model also improves because more page-ad pairs receive impressions to estimate their historical performance.

The system ran a bucket test on method 100 to experiment with the impression based confidence metric C₁. The exploration and exploitation (EE) parameters utilized were r=N*0.1, p=40, q=30, and s=0.5. Note that N refers to the number of advertisements after various filtering, such as budget and account. The number of advertisements N generally falls into the range of [10, 30].

Advertising system 200 measured a short-term performance in two aspects, namely the gain and the loss. Before the experiment, advertising system 200 could expect the advertisement pool to increase in size, measured by the number of unique advertisements with impressions. On the other hand, the click-through rate (CTR) in the exploration and exploitation (EE) bucket may decrease where advertising system 200 displays more advertisements with unknown histories. Furthermore, advertising system 200 may measure how many advertisements with high CTRs are dropped out due to the positions taken by exploration.

Table I below presents the summarized result from a 10-day bucket test:

TABLE 1

| | nCTR bucket | EE bucket | |
|---|---|---|---|
| | (baseline) | Method 100 | Change |
| # unique ads | 891,861 | 986,136 | +10.6% |
| Page-ad CTR | 3.59E−4 | 3.55E−4 | −1.11% |
| # unique | 196,741 | 198,780 | +1.04% |
| high-CTR ads | | | |

In the 10-day bucket test, the test ran a first bucket system (nCTR bucket) and a second bucket system (EE bucket) side by side. The first bucket posted advertisements based on the nCTR score for each advertisement. The second bucket employed method 100 and posted advertisements based both on the nCTR score for each advertisement and on upranking of advertisements. The numbers in the change column are the relative changes for the EE bucket.

As conveyed in Table 1, the number of unique advertisements with impressions significantly increased in the EE bucket. Importantly, the drop in the page-ad CTR was only a slight drop. In other words, the bucket test established that advertising system 200 might display a significant number of upranked advertisement with relatively little impact on generated revenue. Over time and with adjustment of the multiple knobs (b, imp, N, r, p, z, q, s), the number of number of unique advertisements with high CTRs (advertisements with above average advertisement CTR) can be increased.

In a 15-day bucket test that received 0.83% of each days traffic to network entity 202, advertising system 200 received an increase of eleven million new page-ad pairs as a direct result of method 100. In other words, method 100 added 733,000 new page-ad pairs to a test of advertising system 200 each day for a 0.24% increase in coverage. If run full scale using 100% of each day's traffic, advertising system 200 could expect to increase new page-ad pair coverage by up to 28% (0.24%/0.83%). In view of this, method 100 may have a positive impact on CTR in the long run.

Method 100 is an advertisement exploration and exploitation algorithm that may be essential for the marketplace health of performance-based ranking systems like advertising system 200. By modeling the confidence of historical performance, advertising system 200 provide an effective way to identify advertisements with performance potentials. In addition, method 100 provides a high flexibility to control details of the exploration process.

As noted, the above bucket tests have shown promising results. For example, the number of unique advertisements with impressions significantly increased and the coverage of nCTR model improved. While the CTR in the EE bucket dropped by a small percentage, method 100 maintain the same level of unique advertisements with high performance. In view of this, the CTR also may improve once the nCTR model utilizes the exploration feedbacks.

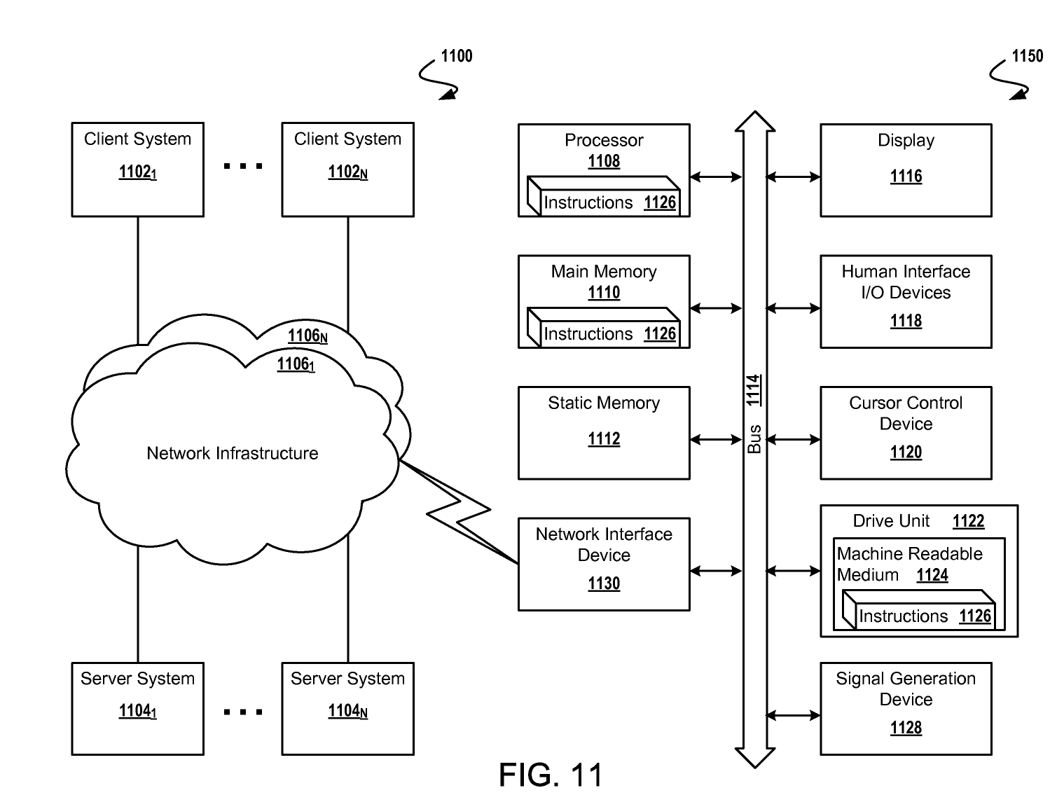

FIG. 11 is a diagrammatic representation of a network 1100. Network 100 may include nodes for client computer systems 1102₁ through 1102_{N}, nodes for server computer systems 1104₁ through 1104_{N}, and nodes for network infrastructure 1106₁ through 1106_{N}. Any of these notes or combination thereof may comprise a machine 1150 within which a set of instructions for causing the machine to perform any one of the techniques discussed above may be executed. The embodiment shown is purely exemplary, and might be implemented in the context of one or more of the figures herein.

Any node of the network 1100 may comprise a general-purpose processor, a digital signal processor (DSP), an application specific integrated circuit (ASIC), a field programmable gate array (FPGA) or other programmable logic device, discrete gate or transistor logic, discrete hardware components, or any combination thereof capable to perform the functions described herein. A general-purpose processor may be a microprocessor, but in the alternative, the processor may be any conventional processor, controller, microcontroller, or state machine. A system also may implement a processor as a combination of computing devices (e.g., a combination of a DSP and a microprocessor, a plurality of microprocessors, one or more microprocessors in conjunction with a DSP core, or any other such configuration, etc).

In alternative embodiments, a node may comprise a machine in the form of a virtual machine (VM), a virtual server, a virtual client, a virtual desktop, a virtual volume, a network router, a network switch, a network bridge, a personal digital assistant (PDA), a cellular telephone, a web appliance, or any machine capable of executing a sequence of instructions that specify actions to be taken by that machine. Any node of the network may communicate cooperatively with another node on the network. In some embodiments, any node of the network may communicate cooperatively with every other node of the network. Further, any node or group of nodes on the network may comprise one or more computer systems (e.g., a client computer system, a server computer system) and/or may comprise one or more embedded computer systems, a massively parallel computer system, and/or a cloud computer system.

The computer system 1150 includes a processor 1108 (e.g., a processor core, a microprocessor, a computing device, etc), a main memory 1110 and a static memory 1112, which communicate with each other via a bus 1114. The machine 1150 may further include a display unit 1116 that may comprise a touch-screen, or a liquid crystal display (LCD), or a light emitting diode (LED) display, or a cathode ray tube (CRT). As shown, the computer system 1150 also includes a human input/output (I/O) device 1118 (e.g., a keyboard, an alphanumeric keypad, etc), a pointing device 1120 (e.g., a mouse, a touch screen, etc), a drive unit 1122 (e.g., a disk drive unit, a CD/DVD drive, a tangible computer readable removable media drive, an SSD storage device, etc), a signal generation device 1128 (e.g., a speaker, an audio output, etc), and a network interface device 1130 (e.g., an Ethernet interface, a wired network interface, a wireless network interface, a propagated signal interface, etc).

The drive unit 1122 includes a machine-readable medium 1124 on which is stored a set of instructions (i.e., software, firmware, middleware, etc) 1126 embodying any one, or all, of the methodologies described above. The set of instructions 1126 also may reside, completely or at least partially, within the main memory 1110 and/or within the processor 1108. The network bus 1114 of the network interface device 1130 may provide a way to further transmit or receive the set of instructions 1126.

A computer may include a machine to perform calculations automatically. A computer may include a machine that manipulates data according to a set of instructions. In addition, a computer may include a programmable device that performs mathematical calculations and logical operations, especially one that can process, store and retrieve large amounts of data very quickly.

It is to be understood that embodiments of this invention may be used as, or to support, a set of instructions executed upon some form of processing core (such as the CPU of a computer) or otherwise implemented or realized upon or within a machine- or computer-readable medium. A machine-readable medium includes any mechanism for storing or transmitting information in a form readable by a machine (e.g., a computer). For example, a machine-readable medium includes read-only memory (ROM); random access memory (RAM); magnetic disk storage media; optical storage media; flash memory devices; electrical, optical, acoustical, or any other type of media suitable for storing information.

A computer program product on a storage medium having instructions stored thereon/in may implement part or all of system 200. The system may use these instructions to control, or cause, a computer to perform any of the processes. The storage medium may include without limitation any type of disk including floppy disks, mini disks (MD's), optical disks, DVDs, CD-ROMs, micro-drives, and magneto-optical disks, ROMs, RAMs, EPROMs, EEPROMs, DRAMs, VRAMs, flash memory devices (including flash cards), magnetic or optical cards, nanosystems (including molecular memory ICs), RAID devices, remote data storage/archive/warehousing, or any type of media or device suitable for storing instructions and/or data.

Storing may involve putting or retaining data in a memory unit such as a storage medium. Retrieving may involve locating and reading data from storage. Delivering may involve carrying and turning over to the intended recipient. For example, information may be stored by putting data representing the information in a memory unit, for example. The system may store information by retaining data representing the information in a memory unit, for example. The system may retrieve the information and deliver the information downstream for processing. The system may retrieve a message such as an advertisement from an advertising exchange system, carried over a network, and turned over to a member of a target-group of members.

Stored on any one of the computer readable medium, system 200 may include software both to control the hardware of a general purpose/specialized computer or microprocessor and to enable the computer or microprocessor to interact with a human consumer or other mechanism utilizing the results of system 200. Such software may include without limitation device drivers, operating systems, and user applications. Ultimately, such computer readable medium further may include software to perform system 200.

Although the system may utilize the techniques in the online advertising context, the techniques also may be applicable in any number of different open exchanges where the open exchange offers products, commodities, or services for purchase or sale. Further, many of the features described herein may help data buyers and others to target users in audience segments more effectively. However, while data in the form of segment identifiers may be generally stored and/or retrieved, examples of the invention preferably do not require any specific personal identifier information (e.g., name or social security number) to operate.

The techniques described herein may be implemented in digital electronic circuitry, or in computer hardware, firmware, software recorded on a computer-readable medium, or in combinations of them. The system may implement the techniques as a computer program product, i.e., a computer program tangibly embodied in an information carrier, including a machine-readable storage device, for execution by, or to control the operation of, data processing apparatus, e.g., a programmable processor, a computer, or multiple computers. Any form of programming language may convey a written computer program, including compiled or interpreted languages. A system may deploy the computer program in any form, including as a stand-alone program or as a module, component, subroutine, or other unit recorded on a computer-readable medium and otherwise suitable for use in a computing environment. A system may deploy a computer program for execution on one computer or on multiple computers at one site or distributed across multiple sites and interconnected by a communication network.

A system may perform the methods described herein in programmable processors executing a computer program to perform functions disclosed herein by operating on input data and generating output. A system also may perform the methods by special purpose logic circuitry and implement apparatus as special purpose logic circuitry special purpose logic circuitry, e.g., an FPGA (field programmable gate array) or an ASIC (application-specific integrated circuit). Modules may refer to portions of the computer program and/or the processor/special circuitry that implements that functionality. An engine may be a continuation-based construct that may provide timed preemption through a clock that may measure real time or time simulated through language like scheme. Engines may refer to portions of the computer program and/or the processor/special circuitry that implements the functionality. A system may record modules, engines, and other purported software elements on a computer-readable medium. For example, a processing engine, a storing engine, a retrieving engine, and a delivering engine each may implement the functionality of its name and may be recorded on a computer-readable medium.

Processors suitable for the execution of a computer program include, by way of example, both general and special purpose microprocessors, and any processors of any kind of digital computer. Generally, a processor may receive instructions and data from a read-only memory or a random access memory or both. Essential elements of a computer may be a processor for executing instructions and memory devices for storing instructions and data. Generally, a computer also includes, or may be operatively coupled to receive data from or transfer data to, or both, mass storage devices for storing data, e.g., magnetic, magneto-optical disks, or optical disks. Information carriers suitable for embodying computer program instructions and data include all forms of non-volatile memory, including by way of example semiconductor memory-devices, e.g., EPROM, EEPROM, and flash memory devices; magnetic disks, e.g., internal hard disks or removable disks; magneto-optical disks; and CD-ROM and DVD-ROM disks. A system may supplement a processor and the memory by special purpose logic circuitry and may incorporate the processor and the memory in special purpose logic circuitry.

To provide for interaction with a user, a skilled person may implement the techniques described herein on a computer. The computer may have a display device, e.g., a CRT (cathode ray tube) or LCD (liquid crystal display) monitor, to display information to the user and a keyboard and a pointing device, e.g., a mouse or a trackball. The user may provide input via these devices to the computer (e.g., interact with a user interface element, for example, by clicking a button on such a pointing device). Other kinds of devices may be used to provide for interaction with a user as well; for example, feedback provided to the user includes any form of sensory feedback, e.g., visual feedback, auditory feedback, or tactile feedback; and input from the user may be received in any form, including acoustic, speech, or tactile input.

The techniques described herein may be implemented in a distributed computing system that includes a back-end component, e.g., as a data server, and/or a middleware component, e.g., an application server, and/or a front-end component, e.g., a client computer having a graphical user interface and/or a Web browser through which a user interacts with an implementation of the invention, or any combination of such back-end, middleware, or front-end components. A system may interconnect the components of the system by any form or medium of digital data communication, e.g., a communication network. Examples of communication networks include a local area network (“LAN”) and a wide area network (“WAN”), e.g., the Internet, and include both wired and wireless networks.

The computing system may include clients and servers. A client and server may be generally remote from each other and typically interact over a communication network. The relationship of client and server arises by virtue of computer programs running on the respective computers and having a client-server relationship to each other. One of ordinary skill recognizes any or all of the foregoing implemented and described as computer readable media.

In the above description, numerous details have been set forth for purpose of explanation. However, one of ordinary skill in the art will realize that a skilled person may practice the invention without the use of these specific details. In other instances, the disclosure may present well-known structures and devices in block diagram form to avoid obscuring the description with unnecessary detail. In other words, the details provide the information disclosed herein merely to illustrate principles. A skilled person should not construe this as limiting the scope of the subject matter of the terms of the claims. On the other hand, a skilled person should not read the claims so broadly as to include statutory and nonstatutory subject matter since such a construction is not reasonable. Here, it would be unreasonable for a skilled person to give a scope to the claim that is so broad that it makes the claim non-statutory. Accordingly, a skilled person is to regard the written specification and figures in an illustrative rather than a restrictive sense. Moreover, a skilled person may apply the principles disclosed to achieve the advantages described herein and to achieve other advantages or to satisfy other objectives, as well.

What is claimed is:

1. A computer-implemented method to optimize selection of low performance ranked messages and high performance ranked messages for display on a network location, the method comprising:
presenting, at a computer, a group of online messages ranked according to performance scores;
processing, in the computer, the ranked group of online messages by:
dividing the ranked group of online messages into a first list, a second list, and a promotion set, wherein each message in the first list has a performance score that is greater than each performance score of messages in the second list and the promotion set;
moving a message within the promotion set to a third list as a function of a confidence value;
moving a message from one of the third list and the second list to the first list based on an experiment event outcome; and
transmitting over a network, from a computer, messages in the first list for display at a recipient computer.

2. The method of claim 1, where dividing the ranked group of online messages into the promotion set includes moving into the promotion set only those messages having a quantity of impressions that is less than a predetermined threshold number of impressions.

3. The method of claim 1, where the confidence value for a first message is a function of a quantity of impressions for that message.

4. The method of claim 3, where the confidence value C₁ for the first message is determined according to the equation
C₁=tan h(imp/b)
where
imp is an average number of impressions,
b is a predetermined number of aggregations in that a b parameter may be a parameter that controls how much historical data may be needed to trust an nCTR score,
tan h is a hyperbolic tangent function, and
C₁ is a message confidence value for a given message.

5. The method of claim 1, where the confidence value for a first message is a function of a statistical distribution of a click-through rate for that message.

6. The method of claim 5, where the confidence value C₂ for the first message is determined according to the equation
C₂=Variance(P(θ|α, β, n, k))
where
α, β are two positive shape parameters that parameterize a continuous probability distribution defined on an interval [0, 1],
n is a number of observed impressions made by a message,
k is a number of observed click-throughs received by a message (both n and k refer to a page message pair),
θ is a click-through rate (CTR) of a given page-message pair and is a random variable that corresponds to an underlying CTR for a page message pair,
P(θ|, α, β, n, k) is a posterior distribution of a CTR given a prior Beta (alpha, beta) and an observations n and k,
Variance of a random variable or distribution (P(θ|α, β, n, k)) is an expected square deviation of that variable from its expected value or mean as a measure of an amount of variation of all scores for a variable (not just extremes which give the range), and
C₂ is a message confidence value for a given message.

7. A computer readable medium containing executable instructions stored thereon, which, when executed in a computer, cause the computer to optimize selection of low performance ranked messages and high performance ranked messages for display on a network location, the instructions for:
presenting, at a computer, a group of online messages ranked according to performance scores;
processing, in the computer, the ranked group of online messages by:
dividing the ranked group of online messages into a first list, a second list, and a promotion set, wherein each message in the first list has a performance score that is greater than each performance score of messages in the second list and the promotion set;
moving a message within the promotion set to a third list as a function of a confidence value;
moving a message from one of the third list and the second list to the first list based on an experiment event outcome; and
transmitting over a network, from a computer, messages in the first list for display at a recipient computer.

8. The computer readable medium of claim 7, where dividing the ranked group of online messages into the promotion set includes moving into the promotion set only those messages having a quantity of impressions that is less than a predetermined threshold number of impressions.

9. The computer readable medium of claim 7, where the confidence value for a first message is a function of a quantity of impressions for that message.

10. The computer readable medium of claim 9, where the confidence value C₁ for the first message is determined according to the equation
C₁=tan h(imp/b)
where
imp is an average number of impressions,
b is a predetermined number of aggregations in that a b parameter may be a parameter that controls how much historical data may be needed to trust an nCTR score,
tan h is a hyperbolic tangent function, and
C₁ is a message confidence value for a given message.

11. The computer readable medium of claim 7, where the confidence value for a first message is a function of a statistical distribution of a click-through rate for that message.

12. The computer readable medium of claim 11, where the confidence value C₂ for the first message is determined according to the equation
C₂=Variance(P(θ|α, β, n, k))
where
α, β are two positive shape parameters that parameterize a continuous probability distribution defined on an interval [0, 1],
n is a number of observed impressions made by a message,
k is a number of observed click-throughs received by a message (both n and k refer to a page message pair),
θ is a click-through rate (CTR) of a given page-message pair and is a random variable that corresponds to an underlying CTR for a page message pair,
P(θ|α, β, n, k) is a posterior distribution of a CTR given a prior Beta (alpha, beta) and an observations n and k,
Variance of a random variable or distribution (P(θ|α, β, n, k)) is an expected square deviation of that variable from its expected value or mean as a measure of an amount of variation of all scores for a variable (not just extremes which give the range), and
C₂ is a message confidence value for a given message.

13. A system to optimize selection of low performance ranked messages and high performance ranked messages for display on a network location, the system comprising:
at least one web server, comprising at least one processor and memory, to present a group of online messages ranked according to performance scores; and
a processing and matching platform, comprising at least one processor and memory, coupled to the web server to divide the ranked group of online messages into a first list, a second list, and a promotion set, wherein each message in the first list has a performance score that is greater than each performance score of messages in the second list and the promotion set, to move a message within the promotion set to a third list as a function of a confidence value, to move a message from one of the third list and the second list to the first list based on an experiment event outcome, and to transmit from the processing and matching platform messages in the first list for display at a recipient computer.

14. The system of claim 13, where dividing the ranked group of online messages into the promotion set includes moving into the promotion set only those messages having a quantity of impressions that is less than a predetermined threshold number of impressions.

15. The system of claim 13, where the confidence value for a first message is a function of a quantity of impressions for that message.

16. The system of claim 15, where the confidence value C₁ for the first message is determined according to the equation
C₁=tan h(imp/b)
where
imp is an average number of impressions,
b is a predetermined number of aggregations in that a b parameter may be a parameter that controls how much historical data may be needed to trust an nCTR score,
tan h is a hyperbolic tangent function, and
C₁ is a message confidence value for a given message.

17. The system of claim 13, where the confidence value for a first message is a function of a statistical distribution of a click-through rate for that message.

18. The system of claim 17, where the confidence value C₂ for the first message is determined according to the equation
C₂=Variance(P(θ|α, β, n, k))
where
α, β are two positive shape parameters that parameterize a continuous probability distribution defined on an interval [0, 1],
n is a number of observed impressions made by a message,
k is a number of observed click-throughs received by a message (both n and k refer to a page message pair),
θ is a click-through rate (CTR) of a given page-message pair and is a random variable that corresponds to an underlying CTR for a page message pair,
P(θ|α, β, n, k) is a posterior distribution of a CTR given a prior Beta (alpha, beta) and an observations n and k,
Variance of a random variable or distribution (P(θ|α, β, n, k)) is an expected square deviation of that variable from its expected value or mean as a measure of an amount of variation of all scores for a variable (not just extremes which give the range), and
C₂ is a message confidence value for a given message.
